(19) United States
(12) Patent Application Publication
(10) Pub. No.: US 2022/0247111 A1
(43) Pub. Date: Aug. 4, 2022

(54) GLAZING HAVING AN ELECTRICAL CONNECTOR

(71) Applicant: CENTRAL GLASS COMPANY, LIMITED, Ube-shi, Yamaguchi (JP)

(72) Inventors: Wladislaw BRONSTEIN, Trier (DE); Olivier FARREYROL, Wasserbillig (LU); Jacob Daniel RIGELMAN, Garrett, IN (US); Hiromi HASE, Kawagoe-shi, Saitama (JP)

(73) Assignee: CENTRAL GLASS COMPANY, LIMITED, Ube-shi, Yamaguchi (JP)

(21) Appl. No.: 17/622,325

(22) PCT Filed: Jul. 1, 2020
(86) PCT No.: PCT/US2020/040491

§ 371 Date: Dec. 23, 2021

Related U.S. Application Data
(60) Provisional application No. 62/870,177, filed on Jul. 3, 2019.

(51) Int. Cl. H01R 13/405; H01R 13/33; H01R 43/24; B32B 17/10; B32B 3/08

(52) U.S. Cl. CPC H01R 13/405; H01R 13/33; H01R 43/24; B32B 17/10376; B29C 45/14434; B32B 3/08; B32B 2307/202; B32B 2315/08; B32B 2457/00; B32B 17/10036

(57) ABSTRACT

An automotive glazing including a glass substrate, an electrically connectable material positioned on the glass substrate, a connector comprising a base and a terminal, a conductive material positioned between the electrically connectable material and the connector, and an anchoring material at least partially surrounding the connector. The terminal of the connector at least partially extends out of the anchoring material, and the anchoring material provides pressure against the connector and binds the connector to the electrically connectable material on the glass substrate.

### CROSS REFERENCE TO RELATED APPLICATION

This application claims priority to U.S. Provisional Application No. 62/870,177 filed on Jul. 3, 2019, entitled “GLAZING HAVING AN ELECTRICAL CONNECTOR,” the content of which is incorporated by reference herein in its entirety.

### TECHNICAL FIELD

The present disclosure generally relates to a glazing having an electrical connector attached to an electrically connectable material on the glazing.

### BACKGROUND

Traditionally, electrical connectors have been soldered to electrically conductive materials in automotive glass via solder having lead. However, new directives have instituted the use of lead-free solders, which have proven difficult, as mechanical stresses at the connectors lead to cracks in an underlying glass. U.S. Pat. No. 9,520,665 (the ′665 patent) discloses an electrically connector attached to a glass plate with a conductive rubber at least partially surrounded by a thermosetting adhesive on the underside of the connector. The process described in the ′663 patent uses heat and pressure from an autoclaving process during glass lamination to adhere the connector to glass.

### SUMMARY OF THE DISCLOSURE

Disclosed herein is a glazing including a glass substrate, an electrically connectable material positioned on die glass substrate, a connector comprising a base and a terminal, a conductive material positioned between the electrically connectable material and the connector, and an anchoring material at least partially surrounding the connector. The terminal of the connector at least partially extends out of the anchoring material, and the anchoring material provides pressure against the connector.

### BRIEF DESCRIPTION OF THE DRAWINGS

The accompanying drawings, which are incorporated into and constitute part of this specification, illustrate one or more example aspects of the present disclosure and, together with the detailed description, serve to explain their principles and implementations.

FIG. 1 illustrates a glazing having a connector, according to an exemplary aspect of the present disclosure;

FIG. 2 illustrates a glazing having a connector, according to an exemplary aspect of the present disclosure;

FIG. 3 illustrates a glazing having a connector, according to an exemplary aspect of the present disclosure;

FIG. 4 illustrates a glazing having a connector, according to an exemplary aspect of the present disclosure;

FIG. 5 illustrates a production flow of a glazing having a connector, according to an exemplary aspect of the present disclosure;

FIG. 6 illustrates a portion of a glazing having a connector, after forming an anchoring material during a forming process according to an exemplary aspect of the present disclosure;

FIG. 7 illustrates a portion of a glazing having a connector, after curing the anchoring material during the forming process according to an exemplary aspect of the present disclosure;

FIG. 8 illustrate a portion of a glazing having a connector, with inadequate density of conductive particles in a conductive material; and

FIG. 9 illustrate a portion of a glazing having a connector, with adequate density of conductive particles in a conductive material, according to another exemplary aspect of the present disclosure.

### DETAILED DESCRIPTION

Glazings, including automotive glazings, may have electrical connectors where power is to be supplied to the glazing or an element of the glazing. Particularly, a coating or print may be powered, for example, to be heated. Printed silver, for example, may be located across the glazing, such as heating lines across a rear window, or in a localized area, such as wiper park heating lines. Coatings or printings may require a connector to provide power from an electrical source to heat the coating or print. The connector may be attached to an outer surface of the glazing, such that in a laminated glazing, the connector may be attached without regard for timing of an autoclave process. Further, some glazings may not be laminated. For example, a rear window may be a tempered glass substrate that is not autoclaved. Among other things, a method of attaching a connector, as disclosed herein, may advantageously work for both laminated and non-laminated glazing.

For purposes of this disclosure, including with reference to the figures, “S1” may refer to an exterior glass substrate surface in a glass product. “S4” may refer to the interior glass substrate surface of a laminated automotive glass product. “S2” may be a glass substrate surface opposite S1 and “S3” may be a glass substrate surface opposite S4. In a laminated glass glazing, S2 and S3 may face each other within the laminated glazing. In a non-laminated glazing, S2 refers to an interior glass substrate surface.

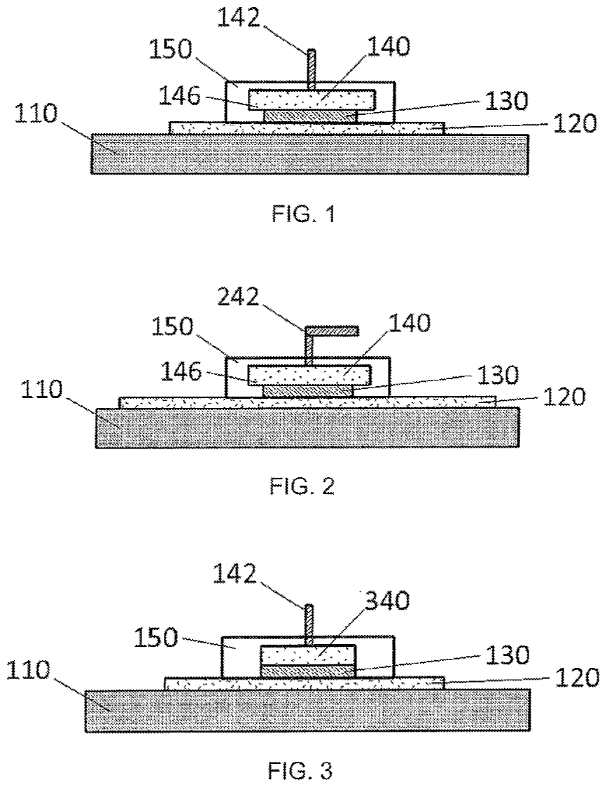

As illustrated in FIG. 1, a glass substrate 110, including single glass substrates and glass substrates which may be part of laminated constructions, may have a coating or print of material 120 which may be electrically connectable. Coatings may, for example, include silver or conductive oxides. In some embodiments the electrically connectable materials 120 may be printed onto the glazing, such as by screen-printing. For example, silver, or silver alloy, may be screen-printed onto a glass substrate 110, including as lines across a rear window for beating and melting snow and ice on the window. Printed electrically connectable materials may further be provided in an area of a windshield or rear window where a wiper may sit in an off position. Such a “wiper park” may include a silver print which is heatable by connection to a power supply. A printed connectable material may be any suitable pattern to provide adequate heating or power to a desired area or areas and may include an area printed for connecting to an electrical connector. In some embodiments, the glazing may include an opaque print at a periphery and/or around an accessory, such as a camera or sensor, and the silver may be printed on the glass and/or an opaque print. The connectable material 120 may be on any suitable glass surface. For example, the connectable material 120 may be on an S2 and/or S4 surface of a laminated glazing. Further embodiments may include connectable material 120 on an S2 surface of a single glass substrate.

A connector may be provided over at least a portion of the electrically connectable material 120 such that power may be transferred to the connectable material 120. The connector may have suitable conductive strength such that a power source may be adequately attached thereto and provide sufficient conductivity to transfer electrical voltage from the power source to the connectable material 120. The connector may be formed of any suitable material, such as a metal, including Ti, Cu, Fe, and alloys including such metals, such as Invar, Kovar, stainless steel, or brass. Alloys may, for example, further include Ni and/or Cr. Preferably, the connector is a Fe alloy. Connectors may further be formed of multiple materials, including multiple metals and/or non-metal materials.

The connectors, as used herein, may include a base 140 and a terminal 142. The connector base 140 may be positioned against the glass substrate 110 and the connectable material 120 with a conductive material 130 therebetween. The connector base 140 may comprise a metal or metal alloy. The connector base 140 may include a bottom surface which is in direct contact with a conductive material 130. Preferably, the conductive material 130 covers a majority of the connector base 140 bottom surface, so as to maximize the electrical connection between the connector and an underlying electrically connectable material 120. The bottom surface of the connector base 140 may be a flat surface or have a non-flat surface for positioning against a conductive material 120. A non-flat surface may include ridges and/or valleys in the surface which may increase the contact area between the conductive material 130 and the connector base 140. Further, a terminal 142 may be provided above the base 140, such that the base 140 is located between the terminal 142 and the glass substrate 110. The terminal 142 may be any suitable material which may be the same or different from the connector base 140 and any suitable form for attachment to a power supply. The terminal 142 and the connector base 140 may be attached to each other by welding, soldering, bolting, riveting, or any other link that ensures mechanical and electrical functions. In particular embodiments, the terminal 142 may be provided as a wire or a metal projection, piece, or tab. In some embodiments, the terminal 142 may be connected to the connector at the connector base 140 or be formed as a solid piece with the connector base 140. Further, the terminal 142 may be oriented in any suitable direction. For example, as shown in FIG. 2, a terminal 242 may be parallel to the connector base 140. In further embodiments, the terminal 142, 242 may be at a non-parallel angle to the connector base 140. In some embodiments a terminal 242 parallel to the connector base 140 may comprise a metal tab. Where the terminal 242 is parallel to the base 140, there may be a greater surface area for connecting a power source without adding height above the glass substrate 110. The power source may be connected to the terminal 142, 242 by any suitable means. Alternatively, the connector base 140 and the terminal 142 may be formed of a wire connecting to the conductive material 130 and may further connect to the connectable material 120 via the conductive material 130. The wire serving as a connector may be embedded in the anchoring material 150 for securing the connection of the wire to the connectable material 120 via the conductive material 130.

There may be one portion of conductive material 130 for each connector. Some glazings may require one or more than one connector, and there may be separate portions of conductive material 130 for each connector. In some embodiments, a single connector may connect to multiple pieces of the conductive material 130, or a single conductive material 130 may connect to multiple connectors. Where there is more than one connector on a glass substrate 110, anchoring material 150 for each connector may be separate or may be in contact with each other.

A conductive material 130 may be provided between the connector and the connectable material 120 to provide a conductive path from the power source connected to the connector terminal 142, 242 to the connectable material 120 on the glass substrate 110. The conductive material 130 may be any suitable material, including having a suitable electrical resistance. Particularly, the conductive material 130 may include metal powder or particles in a resin carrier or carrier matrix. In some embodiments, the conductive material 130 may be provided as a paste, powder, or liquid. In a paste, conductive particles may be dispersed in a carrier liquid. The conductive particles may include particles, nano fibers, or wool fibers of conductive material, such as metal, metal alloy, or carbon. For example, the conductive particles may include metal particles or nanowires, including silver, copper, gold, palladium, or nickel; carbon particles; carbon nanotubes; graphene; graphene platelets; or metal platelets. The carrier liquid may preferably be an organic solvent, adhesive, or resin without adhesion. In some embodiments, the conductive material 130 may not include some metals, such as Pb, Sn, and/or In, having relatively low melting points, because the conductive material 130 is not required to have a diffusive property to increase adhesive force to the connectable material 120. That is, in a conventional glazing, some metals having a low melting point may be diffused to the layer below to obtain adequate adhesiveness and conductivity between the connectable material 120 and the conductive material 130, but, in this disclosure, an anchoring material 150 operates to bind the connector base 140, the conductive material 130, and the connectable material 120, firmly as described below, so that such diffusion may no longer be necessary in the production process. In some embodiments, the conductive material 130 may cover at least 50% of bottom surface of the connector base 140, preferably at least 70%, more preferably at least 80%, and even more preferably at least 90%. Where the conductive material 130 may deoxidize the surface of the connectable material 120 and the bottom surface of the connector base 140, it may be advantageous to position the conductive material 130 between the connectable material 120 and the connector base 140. If the surfaces of the connectable material 120 and the connector base 140 tend to be oxidized, deoxidization from the conductive material 130 may reduce contact resistance at the surfaces of the connectable material 120 and the connector base 140, thereby reducing power loss at the contact surfaces.

As shown in FIG. 3, in some embodiments, the conductive material 130 may contact all of the bottom surface of the connector base 340. The conductive material 130 may form a suitable connection between the connector and the connectable material 120. In some embodiments, the conductive material 130 may fill a space between the connector base 140 and the connectable material 120 completely. In further embodiments, the conductive material 130 may be compressible, such that under pressure, the conductive material 130 compresses and fills the entire space between the connector and the connectable material 120.

Pressure may be formed against the conductive material 130 with the non-conductive anchoring material 150 at least partially on and around the connector and the conductive material 130. In addition to providing pressure against the connector, an anchoring material 150 may adhere the connector to the glass substrate 110 and the connectable material 120. The conductive material 130 used under the connector may have some adhesive properties, however, traditional conductive adhesives strong enough to adhere the connector to the glass substrate 110 may not have enough conductivity to provide a suitable electrical connection to the connectable material 120. As such, the anchoring material 150 which adheres the connector to the glass substrate 110 may allow for a more conductive material 130 to be used. The anchoring material 150 may be provided around and over the connector, such that the area around the connector and the conductive material 130 is filled with the anchoring material 150. The anchoring material 150 may be any suitable material compatible with the connector, connectable material 120, conductive material 130, glass 110, and, where applicable, an opaque print. Particularly, the anchoring material 150 may adhere to the connector, connectable material 120, glass 110, and an opaque print where applicable. The connector may be provided on an outer glass substrate 110 surface and the anchoring material 150 may be exposed to environmental conditions. Preferably, the anchoring material 150 may be suitable to prevent corrosion or damage due to physical or chemical elements in the glazing environment, such as a vehicle interior.

The anchoring material 150 may have anisotropic mechanism property of elongation, elasticity, viscosity, and Young's modulus, for example, vertically a high strength and compressive capability to keep rigidity and compression of the conductive material 130 but still some softness in the horizontal direction to avoid shear stress over the glass substrate 110 and the connectable material 120. This may be achieved from using composite techniques publicly known such as fibers, fillers, or directional materials for producing anisotropy in orientation in the anchoring material ISO.

Further, the anchoring material 150 may shrink upon curing, such that the anchoring material 150 may be placed around the connector and cured such that the cured anchoring material 150 has less volume than the uncured anchoring material ISO. Preferably, the anchoring material 150 may shrink from an initial size to a cured size by at least about 0.5%, more preferably at least about 1.0%, and even more preferably at least 1.15%. In certain embodiments, the anchoring material 150 may shrink from 0.5% to 2.0%, preferably from 1.0% to 1.8%, and more preferably from 1.15% to 1.6%. The anchoring material's preferable shrinkage may depend on elasticity of the anchoring material 150. For example, where the anchoring material 150 has low elasticity, it may desirably have a low shrink value.

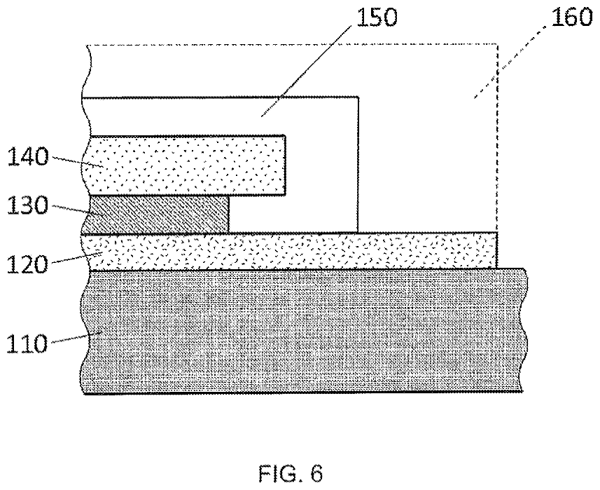

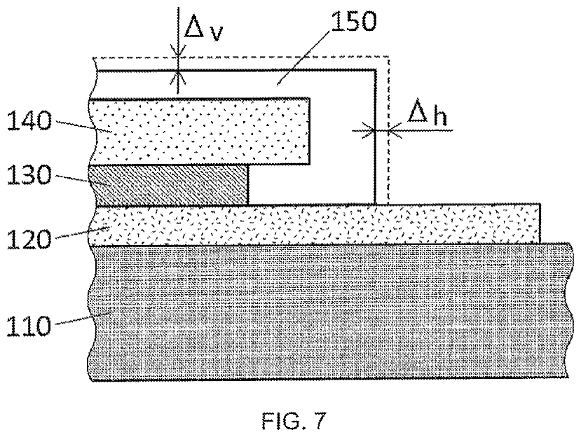

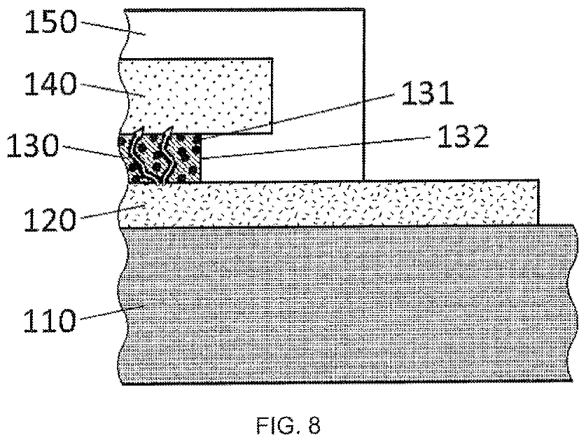

FIG. 6 illustrates a cross section of the glazing at a process before curing process; FIG. 7 illustrates a cross section of the glazing after curing process. In FIG. 6, the anchoring material 150 is formed on the connector base 140 to embed the conductive material 130 and the connector base 140 on the connectable material 120 within the anchoring material 150. To form the anchoring material 150, a mold 160, illustrated with a dotted line, may be used to form the anchoring material 150 as to bind firmly the conductive material 130 below the connector base 140. When the anchoring material 150 is cured by heat application, the anchoring material 150 may shrink as shown in FIG. 7. In this embodiment, the anchoring material 150 may be shrunk in an anisotropic way, such that a vertical shrinking difference Δv is not the same to a horizontal shrinking difference Δh. In some embodiments, the anchoring material 150 may shrink in the vertical direction more than in the horizontal direction, therefore exerting more vertical pressure against the connector base 140 and the conductive material 130.

Further, the elasticity of the anchoring material 150 may impact a pressure applied to the connector. For example, a more elastic anchoring materials (having a low E modulus) may not provide sufficient pressure on the connector. Pressure may be desirably maintained on the connector to provide connection to the connectable material 120 to provide electrical power thereto. An exemplary anchoring material 150 may have an E-modulus from 5 to 25 MPa, preferably from 10 to 20 MPa, and more preferably from 12 to 18 MPa.

The anchoring material 150 may provide pressure against the connector as it is attached to the glass substrate 110 surface around the connector and to the connector base 140 creating compression therebetween when shrunk. The amount of anchoring material 150 used may depend in part on the adhesion of the anchoring material 150. As a larger area around the connector may be covered with the anchoring material 150 where the anchoring material 150 is less adhesive compared to an anchoring material 150 which may have sufficient adhesion with a smaller amount of anchoring material 150. The uncured anchoring material 150 may be viscous such that the anchoring material 150 may fill the area around the connector sufficiently prior to curing to provide sufficient compression and adhesion around the connector. The compression against the connector may further compress a compressible conductive material 130 against the connectable material 120 and the glass substrate 110. The amount of compression felt by the conductive material 130 may at least partially depend on characteristics of the anchoring material 150, including the shrinking, the E-Modulus, the K-modulus. Poisson's ratio, and/or the initial pressure during application of the anchoring material 150. For example, compression may relate directly to shrinkage of the anchoring material 150, where an increasing shrinkage may provide increasing compression of the conductive material 130. As shrinkage of the anchoring material 150 increases, the pressure put on the connector towards the glass substrate 110 may increase. In some embodiments, the connector may be under pressure during application of the anchoring material 150. Pressure on the connector during application of the anchoring material 150 may increase the total compression on the conductive material 130 when the anchoring material 150 is cured. Tooling may, in some embodiments, be used to apply pressure to the connector. Preferably the tooling does not adhere to the anchoring material 150. Further, the anchoring material 150 may not surround the connector where pressure is applied to the connector.

The terminal 142, 242 of the connector may extend out of the anchoring material 150, such that it is exposed outside of the anchoring material 150. The terminal 142, 242 may then be available to connect a power source the connector and power the connectable material 120 thereunder. The terminal 142, 242 may be provided above the connector base 140, 340, 440 and the anchoring material 150 as shown in FIGS. 1-4. In some further embodiments, the terminal 142, 242 may extend through the anchoring material 150 towards a side of the connector base 140.

The anchoring material 150 may be mono-component, which may be cured, or multi-component, which may be reacted and/or cured. In certain embodiments, the anchoring material 150 may be a two component material which cures upon mixing of the material components. The anchoring material ISO may include a polymer, such as a polyurethane or an epoxy, and may be mono-component to be cured or multi-components to be reacted or cured. Particularly, for example, a two component polyurethane may be used around the connector as the anchoring material 150. The anchoring material 150 may have enough strength to adhere the connector to the glass substrate 110 but may not crick the glass substrate 110 thereunder. Where an adhesive, such as some epoxies, am too strong, the mechanical stress of the adhesive may transfer to the glass of the glazing, causing cracks. In further embodiments, the anchoring material 150 may be cured by electromagnetic wave radiation or heat treatment. Electromagnetic wave radiation may include ultraviolet (UV), infrared (IR), or a visible light. In some embodiments, the anchoring material ISO may be filled in a mold placed around the connector before curing the anchoring material 150. A viscous anchoring material 150 may fill the mold, including areas around the connector. After curing, the mold may be removed from the glazing and the anchoring material 150.

In some embodiments, the anchoring material ISO may include a frit, which may be formed from an inorganic or organic material. The connection of a connector to glass with frit could be prepared before or after lamination where laminated glass is used. The process of curing the frit may be used together with a curing process of a polymer or polymers which may be mixed with the frit. The inorganic or organic materials may be bonded when pressed and heated to form a solid material, and such material may be doped with minerals, metals, or other particles to gain certain mechanical properties such as anisotropic strength or extension properties.

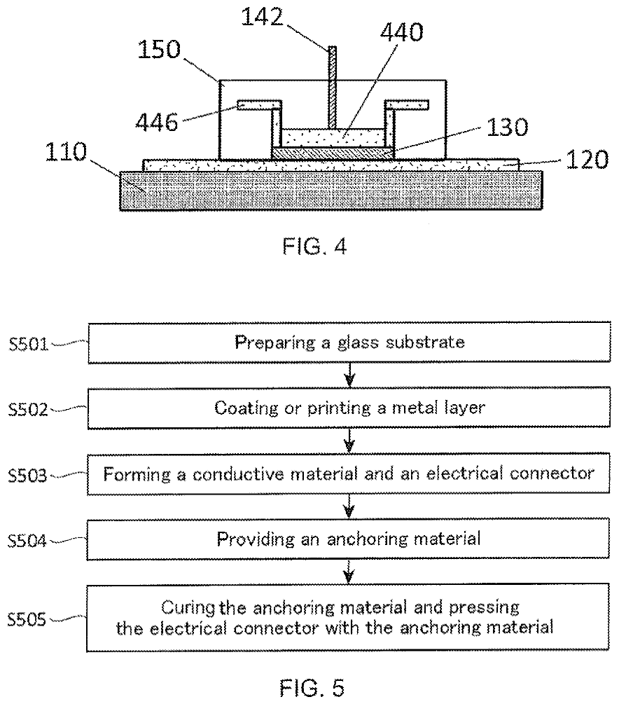

In further embodiments, the connector may be formed to provide extensions which are not in contact with the conductive material. FIG. 4 illustrates a glass substrate 110 having a connector base 440 with extensions 446 and terminal 142. The anchoring material 150, as shown, may cover the extensions 446 and kill the space below the extensions 446 and above the connectable material 120 and the glass substrate 110. When the anchoring material 150 curs and shrinks, pressure may be put on the extensions 446 from above and below, increasing the pressure put on the connector and the compression of the underlying conductive material 130. The extensions 146, 446 may be on the same plane or different from the connector base 140, 440. FIG. 1 illustrates extensions 146 on the same plane as the connector base 140. The extensions 146, 446 may be any desirable height where the anchoring material ISO is provided at least to a level above the extensions 146, 446. Space constraints may provide a need for a lower connector where the extensions 146 are on the same or a similar plane to the connector base 140. The connector may be selected to provide desired properties, including necessary compression.

The anchored connector may be provided on the glazing, including a laminated glazing, at any suitable time during production. In some embodiments, such as where the anchoring material 150 is curable by electromagnetic wave radiation or cures upon mixing of material components, the connector may be attached without additional heat treatment. Particularly, the connector may be attached to the glass substrate 110 without regard for the lamination process. The lamination process may include an autoclave treatment, including high temperature and pressure. The autoclaving process typically includes heating to a laminating temperature, such as 110° C. to 160° C., under a laminating pressure, such as 10 to 15 bar. Connectors may add depth to a glazing, such that each glazing may take more space in an autoclave. As an autoclave is an enclosed space, which may have limited room for products during an autoclaving cycle, it may be preferable to be able to provide a connector on a glass substrate 110 after an autoclaving process. Anchoring materials 150 cured without heat may be used outside of the autoclaving process, including after autoclaving. Further, process steps, including, for example, moving a glazing into an autoclave, between application of an adhesive and curing of the adhesive may be reduced where the anchoring material 150 may be applied and cured in a single step or at a single production location, which may reduce the number of parts which show defect due to an unsuccessful connector application. Further, additional defects may be identified alter an autoclave process, so delaying connector attachment to after the autoclave process may reduce the connectors unnecessarily used on defective parts.

Additionally, a heat independent connector attachment process may provide flexibility of connector materials. Some materials may not be compatible with the heat of an autoclave or other heat treatments, including some non-metal materials. Applying an anchoring material 150 which may cure without heat treatments may provide opportunity for applying a connector which would not be suitable for thermal applications.

Further, electrical connectors may be required on a glass substrate 110 that is not laminated, such as a tempered rear window. A tempered glazing may include a single glass substrate which is not autoclaved. Thus, there is a need for connectors attached outside of such a process. As described herein, an anchoring material 150 may be used to apply a connector to laminated or non-laminated glass substrate 110.

In some embodiments, a glazing having a connector may be formed by methods described herein. The glazing may be prepared having a connectable material 120. The connectable material 120, for example, may be printed or coated onto the glazing. In some embodiments, the connectable material 120 may be formed on the glass substrate 110 of the glazing prior to, during, or after the glazing is constructed, including tempering and/or lamination.

A connector may be positioned over the connectable material 120 where a conductive material 130 is between the connector and the connectable material 120. The connector may preferably be positioned over a busbar in some embodiments. The conductive material 130 may be formed on the connector before the connector is positioned over the connectable material 120. In certain embodiments, a mold may be placed around the connector. The mold may be filled with an anchoring material 150, wherein the anchoring material 150 may fill an area around and above the connector. The connector may have a terminal portion 142, 242 connectable to a power source which extends out of the anchoring material 130. The anchoring material 150 may then be cured by any suitable means, such as ultraviolet curing. In some embodiments, pressure may be applied to the connector when the anchoring material 150 is applied. Pressure against the connector may be removed after the anchoring material 150 is cured. Further, after curing of the anchoring material 150, the mold may be removed.

FIG. 5 shows a production flow of the glazing according to this disclosure. First, at Step S501, to produce the glazing according to this disclosure, a glass substrate may be prepared. The glass substrate may be a single flat glass or laminated to another glass substrate with a polymer interlayer therebetween. Subsequently, a metal layer, such as silver layer, may be formed on the glass substrate by a screen printing method or other suitable method at Step S502. The metal layer may serve as a connectable material for heating, or any other means activated by power supply. The metal layer may also provide for an antenna which may be passive without a power supply. Thus, the materials and methods described herein may be used for an active or passive component, with or without a power supply. After forming the metal layer, a conductive material 130 and connector may be positioned on the metal layer at Step S503. The conductive material may be provided on the metal layer, and then the connector may be provided on the conductive material. Alternatively, the conductive material may be provided first on the bottom surface of the connector, and the connector, having the conductive material thereon, may be provided together on the connectable material in a way to likewise place an adhesive tape on a material. Alternatively, the connector may be positioned above the connectable material, such that there is a gap between the connector and the connectable material, and then the conductive material may be formed as to fill the gap between the connector and the connectable material. After providing the connector and the conductive material on the connectable material and the glass substrate, an anchoring material may be provided at Step S504 on the connector as to entirely embed the connector in the anchoring material except the terminal. The anchoring material may preferably be chosen from polymers, such as epoxy, polyurethane, or any other suitable polymers, and, in an uncured stage, may be held in a mold to provide a desired shape to the polymer to embed the connector and the conductive material on the connectable material. After the anchoring material is provided, the anchoring material may be cured to secure the connector to the connectable material with the conductive material therebetween at Step S505. After the completion of the curing process, the mold may be removed from the glazing.

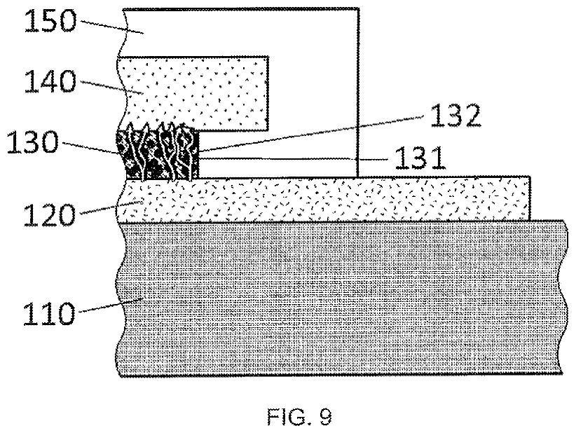

In some embodiments, the conductive material 130 may be formed of conductive particles 131 in a carrier matrix 132. FIG. 8 and FIG. 9 illustrate a portion of a glazing having a connector, with conductive particles in a carrier matrix 132. FIG. 8 illustrates a situation in which the carrier matrix 132 contains an insufficient concentration of conductive particles 131 such that there may not be adequate conductivity between the connectable material and the connector. The conductive particles 131 may be formed of, e.g., fine metal or fine metal alloy particles, carbon particles, nano fibers, or wool fibers, etc. In certain embodiments, the conductive particles may be formed of more than one type of particles or powders. The carrier matrix 132 may preferably be formed of a polyolefin, epoxy, or polyurethane and may be suitable for serving as a matrix holding the conductive particles 131 and possibly adhering to the connectable material 120 and the connector base 140. The carrier matrix 132 may or may not adhere to the connectable material 120 and the connector base 140. Because the carrier matrix 132 itself may be non-conductive, the conductive particles 131 may together form conductive paths electrically connecting the connectable material 120 and the connector. FIG. 9 illustrates an example in which the carrier matrix 132 contains the conductive particles 131 in a concentration which may provide adequate conductivity. With this structure, there may be sufficient conductive particles 131 to form paths for current to flow between the connectable material 120 and the connector, leading to increased conductivity over a conductive material 130 with a lower concentration of conductive particles 131. The paths for current flow may be formed by conductive particles positioned next to each other, such that an electrical current may pass from one conductive particle to another. This increased conductivity may be useful, for example, for defrosting capabilities.

Methods described herein may be used to provide glazings having an electrical connector which is applied to a glass substrate without applying heat to the glazing and may have sufficient electrical and mechanical strength and durability.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A glazing, comprising:
a glass substrate;
an electrically connectable material positioned on the glass substrate;
a connector comprising a base and a terminal;
a conductive material positioned between the electrically connectable material and the connector; and
an anchoring material at least partially surrounding the connector,
wherein the terminal of the connector at least partially extends out of the anchoring material, and wherein the anchoring material provides pressure against the connector.

2-5. (canceled)

6. The glazing according to claim 1, wherein the glass substrate comprises a first surface and a second surface opposite the first surface, wherein the electrically connectable material is on the second surface of the single glass substrate.

7. The glazing according to claim 1, wherein a first glass substrate is laminated to a second glass substrate and the glass substrate is one of the first glass substrate and the second glass substrate, wherein the first glass substrate has a first surface and a second surface opposite the first surface and the second glass substrate has a third surface and a fourth surface opposite the third surface, wherein the second surface faces the third surface.

8-10. (canceled)

11. The glazing according to claim 1, wherein the connector further comprises extensions.

12. The glazing according to claim 11, wherein the extensions are raised above the plane of the connector base.

13. The glazing according to claim 11, wherein the extensions are parallel to the connector base.

14-18. (canceled)

19. The glazing according to claim 1, wherein the anchoring material is liquid before curing.

20. The glazing according to claim 1, wherein the anchoring material is a polymer material.

21. The glazing according to claim 20, wherein the anchoring material is an epoxy.

22-23. (canceled)

24. The glazing according to claim 20, wherein the anchoring material is a polyurethane.

25. The glazing according to claim 1, wherein the connector base comprises a bottom surface, wherein the bottom surface is entirely in contact with the conductive material.

26. The glazing according to claim 1, wherein the conductive material is compressed.

27. The glazing according to claim 1, wherein the conductive material includes a metal.

28. The glazing according to claim 1, wherein the conductive material is deoxidizing with respect to at least one of the connectable material and the connector.

29. A method of forming a glazing with a connector, comprising:
providing a glass substrate;
providing a connectable material on the glass substrate;
providing a conductive material and a connector positioned over the connectable material, wherein the conductive material is positioned between the connector and the connectable material;
applying an anchoring material at least partially surrounding the connector; and
curing the anchoring material.

30. The method according to claim 29, wherein the anchoring material is applied in a mold, wherein the mold is placed around the conductive material and the connector.

31-32. (canceled)

33. The method according to claim 29, wherein the anchoring material reduces in size when cured.

34. The method according to claim 33, wherein the anchoring material reduces in size by at least 0.7% when cured.

35-36. (canceled)

37. The method according to claim 29, wherein the connector is under pressure during application of the anchoring material.

38. The method according to claim 29, wherein providing the conductive material and the connector positioned over the connectable material includes placing the conductive material on the connectable material and then placing the connector over the conductive material.

39. The method according to claim 29, wherein providing the conductive material and the connector positioned over the connectable material includes placing a connector having a conductive material formed thereon over the connectable material.
